(19) United States
(12) Patent Application Publication
(10) Pub. No.: US 2022/0002537 A1
(43) Pub. Date: Jan. 6, 2022

(54) CYCLIC OLEFIN POLYMER CONCENTRATE FOR POLYESTER-BASED MATERIALS

(71) Applicant: Holland Colours N.V., Apeldoorn (NL)

(72) Inventors: Johan Jozef Marinus WERINK, Balkbrug (NL); Jules Caspar Albert Anton ROELOFS, Twello (NL)

(73) Assignee: Holland Colours N.V., Apeldoorn (NL)

(21) Appl. No.: 17/295,729

(22) PCT Filed: Nov. 22, 2019
(86) PCT No.: PCT/NL2019/050775

§ 371 Date: May 20, 2021

(30) Foreign Application Priority Data
Nov. 23, 2018 (EP) 18208159.6

(51) Int. Cl. C08L 65/00; C08K 3/22; C08L 23/08; C08L 67/02; C08J 3/22

(52) U.S. Cl. CPC C08L 65/00; C08K 3/22; C08L 23/0823; C08L 2203/10; C08J 3/226; C08K 2003/2241; C08L 67/02

(57) ABSTRACT

The invention discloses a concentrate comprising cyclic olefin polymer and titanium dioxide, a compound formulation, a process for preparing coloured polyester, a process for preparing polyester-based containers, and a container product. The concentrate of the invention comprises 10-90% by total weight of the concentrate of cyclic olefin polymer, and 20-80% by total weight of the concentrate of titanium dioxide.

The invention is directed to a concentrate comprising cyclic olefin polymer and titanium dioxide, to a compound formulation, to a process for preparing coloured polyester, to a process for preparing polyester-based containers, and to a container product.

The invention relates to the use of cyclic olefin polymers as opacifiers for polyester preforms and containers, such as bottles.

Plastics, such as polyesters, are commonly used as packaging material. For example, polyethylene terephthalate (PET) is a common material used for example for manufacturing bottles, films, and microwavable packaging.

Standard PET packaging does not provide a light barrier in the ultraviolet (UV) and visible part of the electromagnetic spectrum in the wavelengths between 320-700 nm. Below 320 nm, PET absorbs light and thereby prevents light sensitive compounds to be affected by this light. While conventional PET bottles have little intrinsic light shielding, coloured PET on the other hand, has better light shielding.

Colouring plays an important practical function. For example, certain colours are used to protect light sensitive compounds from degradation as a result of exposure to UV and visible light. Examples of products that include such light sensitive compounds are dairy products, such as milk, and beverages, such as beer and juice.

Therefore, a light barrier needs to be added to the conventional PET bottle to protect the content from degradation. This can for example be achieved by mixing a colorant into PET, or by putting a light protective film around a bottle—containing the pigment. Another way of protecting light sensitive compounds from degradation is achieved by using a multi-layered bottle instead of a mono-layered one, for example comprising different (coloured) polymers.

Titanium dioxide (TiO₂) is a well-known pigment with a high refractive index. The inorganic compound is applied in the plastic industry because of its high covering power, whiteness, heat resistance, and weather resistance. Despite the advantageous effects, the use of titanium dioxide also has drawbacks.

Incorporating titanium dioxide into PET packaging material significantly reduces, yet does not completely, eliminate light transmittance. The presence of low to moderate levels of titanium dioxide still allow some light transmittance in the critical visible light area. By incorporating high levels of titanium dioxide in packaging material (i.e. 4% or more, based on the total weight of the packaging material), it has become possible to obtain an opaque material having a degree of transmittance that is low enough to store dairy products for a sufficiently long period of time.

To decrease the transmittance even further of the portions of UV and visible light that are detrimental to the shelf life of dairy products, additional light absorbing additives could be included. Examples thereof are (mixed) metal oxides, carbon black, and organic additives, such as polymethylpentene and cyclic olefin polymers.

For example, WO-A-2019/117725 describes a concentrate comprising polymethylpentene and titanium dioxide, with which polyester preforms and containers can be manufactured. While these preforms and containers contain less than 4 wt. % of titanium dioxide, the light protection and white appearance are barely affected.

US-A-2015/0 041 839 describes an electron beam curable resin composition having improved heat resistance. Several resin compositions are disclosed, including one composition comprising 48 wt. % cyclic polyolefin copolymer (copolymer consisting of ethylene and norbornene units from Mitsui Chemicals) as the resin, 1 wt. % of a crosslinking agent, 21 wt. % of titanium oxide and several additives. The resin composition is used as such to mould a moulded body. Hence, this document does not disclose a concentrate.

KR-B-101 450 840 describes a white porous polyester foil comprising 10 wt. % of titanium dioxide 10 wt. % of norbornene-ethylene copolymer, and a polyethylene terephthalate derivative.

WO-A-2007/058506 reveals porous single-layer polyester films for use in printing, labelling, electronics and display applications. The film comprises PET, 12 wt. % titanium dioxide, 13 wt. % cyclic olefin copolymer (norbornene-ethylene copolymer), and a whitening agent.

The light protection property of PET bottles, for example, can be further extended by use of a multi-layered polyester structure. Multilayer bottles (e.g. a structure of PET with TiO₂/black layer (PET)/PET with TiO₂) do not result in light transmittance, however, the black layer (middle) shines through the bottle resulting in a grey appearance. In addition, such a multilayer is relatively expensive, processing is more difficult, and recyclability is complicated.

WO-A-01/92012 expresses the need for white polyester multi-layered films that exhibit a very high gloss, improved manufacturability, and low production costs. The polyester film consists of at least one base layer and at least one cover layer, comprising 3-10 wt. % cyclic olefin copolymer (2-norbornene-ethylene copolymer) and optional additives, such as barium sulphate and titanium dioxide.

Two-layered structures are possible as well. Herewith, the bottle has a greyish layer on the inside and a white layer on the outside, which gives near complete protection against both UV and visible light. Overcolouring of the grey layer requires a high amount of titanium dioxide. The use of high levels of mineral opacifiers, like titanium dioxide, caused a decreased lifespan of moulds for mono- and multi-layered structures, due to an increased abrasive wear of the equipment.

Therefore, there is an industrial need to develop a manner to circumvent the loss in light protection when the content of mineral opacifying agents in PET containers is drastically lowered, and maintaining a white appearance. In addition, there is a need to develop a manner with which the life span of moulds for multilayer packaging producers is extended.

There is further a need to diminish the effect different blow moulding settings have on the quality of PET containers. Furthermore, weight reduction, improved recyclability, and lower raw material costs as well as production costs are considered to be industrial needs for coloured PET containers.

An objective of the invention is to overcome one or more of the disadvantages faced in the prior art.

Yet a further objective of the invention is to provide a concentrate with which polyester preforms and/or containers can be manufactured having a lower raw material usage and production costs, without significantly reducing the light protection and white appearance.

Yet a further objective of the invention is to provide a concentrate with which mono-layered and multi-layered polyester packages can be manufactured that extent the lifespan of the moulds, without significantly reducing the light protection and white appearance.

Yet a further objective of the invention is to provide a process for preparing a polyester container and/or preform with a low titanium dioxide content, resulting in weight reduction, and lower raw material as well as production costs, without significantly reducing the light protection and white appearance.

The inventors found that one or more of these objectives can, at least in part, be met by providing a concentrate comprising cyclic olefin polymer and titanium dioxide for preparing polyester preforms and containers.

Accordingly, in a first aspect of the invention there is provided a concentrate comprising 10-90% of cyclic olefin polymer, and 20-80% of titanium dioxide, based on the total weight of the concentrate.

According to another aspect of the invention, there is provided a compound formulation comprising titanium dioxide, cyclic olefin polymer, and polyester, wherein the amount of titanium dioxide is 20% or less, and the amount of cyclic olefin polymer is 1-15%, both based on the total weight of the compound formulation.

According to another aspect of the invention, there is provided a process for preparing coloured polyester, the process comprising producing coloured polyester by bringing polyester into contact with the concentrate as described herein and/or the compound formulation as described herein.

According to another aspect of the invention, there is provided a process for preparing polyester-based containers suitable for storing solids and/or liquids and having 4% or less (light) transmittance at 550 nm and about 0.25-0.30 mm sample thickness, the process comprising producing a preform for the polyester-based containers from polyester and the concentrate as described herein or the compound formulation as described herein, and moulding the preform into a container.

According to another aspect of the invention, there is provided a container product, wherein the amount of cyclic olefin polymer is 5% or less, and/or the amount of titanium dioxide is 8% or less, based on the total weight of the polyester-based container.

The invention provides a concentrate with which polyester preforms and/or containers may be coloured having a lower titanium dioxide content, having a lower weight and/or lower production costs, yet, without significantly reducing light protection and/or white appearance.

In accordance with the invention, a concentrate comprising titanium dioxide and cyclic olefin polymer is provided with which mono-layered and/or multi-layered polyester-based preforms and/or containers can be manufactured having a lower abrasive titanium dioxide content. Due to the lower amount of abrasive titanium dioxide, a possible adverse effect on lifespan of the moulds can be reduced.

The invention provides a concentrate comprising 10-90% of cyclic olefin polymer, and 20-80% of titanium dioxide, based on total weight of the concentrate.

The term “concentrate” as used herein is meant to refer to a substance or composition that can suitably be used in a polymer composition (preferably a thermoplastic polymer composition, such as a polyester). The substance or composition may be prepared by concentrating one or more chemical compounds. The concentrate typically comprises a component which is present in the concentrate at a higher level than intended for the final polymer composition. Hence, in accordance with the invention the concentrate of the invention that is intended for use in preparing preforms and/or containers has a higher level of cyclic olefin polymers and titanium dioxide, than the resulting preforms and/or containers. The concentrate is characterised in that it is easy to dose, and having the advantage that it is possible to add the required amounts of cyclic olefin polymer and titanium dioxide together to a polymer composition without unduly adding separate chemical compounds and/or unwanted other components in large amounts to the polymer composition. The concentrate is intended to be incorporated in a polymer composition, and is not used as a coating on the surface of an article. Typically, the concentrate can be characterised as an intermediate product, primarily destined for further processing to acquire finished polymer products. Such concentrates are well-known in the technical field to influence one or more chemical and/or physical properties (such as light transmittance and colour) of a polymer composition. In the art, the term “concentrate” and “masterbatch” are used interchangeably. In particular, 80% or more by total weight of the concentrate consists of cyclic olefin polymer and titanium dioxide together, preferably as 90% or more, preferably, 95% or more, such as 98% or more. At production temperatures, the concentrate may be solid or liquid. Preferably, the concentrate is solid at room temperature, and liquid at production temperature. Furthermore, the concentrate may be mixed with one or more commercially available concentrates.

The concentration of cyclic olefin polymer in the concentrate is 10% to 90%, based on the total weight of the concentrate. In particular, the cyclic olefin polymer (COP) content may be 25% or more and 85 or less %, based on the total weight of the concentrate. Preferably, the amount of cyclic olefin polymer in the concentrate is 35-80% by total weight of the concentrate, more preferably 49-78%. Cyclic olefin polymer amounts below 15% by total weight of the concentrate may result in poorly dispersed pigments and processing issues during application of such concentrates in the production of packaging materials, while amounts above 90% by total weight of the concentrate may have a negative effect on the cost effectiveness of the production process.

The concentration of titanium dioxide in the composition of the concentrate is 10-80%, based on the total weight of the concentrate. In particular, the amount of titanium dioxide may be 15% or more and 75% or less, based on the total weight of the concentrate. Preferably, the amount of titanium dioxide in the concentrate is 20-70% by total weight of the concentrate, more preferably, 30-70%. Titanium dioxide may be present in various forms, including ilmenite, rutile, anatase, brookite, akaogiite, metastable phases, high pressure forms or a mixture thereof. Preferably, the titanium dioxide is present as rutile, anatase, or a mixture thereof. Suitable grades of titanium dioxide are for example commercially available from companies like DuPont, Crystal, and Kronos.

The term “cyclic olefin polymer” as used herein is meant to refer to cyclic olefin homopolymers, cyclic olefin copolymers and/or a mixture of cyclic olefin homopolymers and cyclic olefin copolymers. Whereas the term cyclic olefin homopolymers as used herein is meant to refer to polymers comprising a single kind of monomer, the term cyclic olefin copolymers as used herein is meant to refer to polymers comprising at least one kind of monomer and/or comonomer. Cyclic olefin copolymers are produced by copolymerisation of e.g. ethylene with a cyclic olefin monomer, such as norbornene, phenyl norbornene, dihydro dicyclopentadiene, and tetracyclododecene, tetracyclododecene norbornene, dicyclopentadiene, dimethyloctahydronaphthalene, and cyclopentene. The cyclic olefin monomers are, for example norbornene, cyclopentadiene or dicyclopentadiene, or derivatives thereof. Ziegler-Natta and metallocene catalysts are commonly used in polymerisation processes. Cyclic olefin copolymers resins have excellent transparency, near zero birefringence, low density, low water uptake, and good chemical resistance.

The concentrate as described herein may comprise one or more cyclic olefin homopolymers. A cyclic olefin homopolymer may generally be considered a homopolymer comprising a single kind of monomer. The one or more cyclic olefin homopolymers may, for example, comprise one or more of the above-mentioned cyclic olefin monomers. In particular, norbornene, norbornene derivatives, and cyclopentene derivatives are preferred monomers. More preferably, the one or more cyclic olefin homopolymers comprise one or more monomers from norbornene derivatives, and cyclopentene derivatives.

The concentrate as described herein may comprise one or more cyclic olefin copolymers. The one or more cyclic olefin copolymers may be considered a copolymer comprising one or more monomeric units of an aliphatic olefin and one or more monomer units of a cyclic olefin. The aliphatic olefin monomer may, for example, comprise one or more selected from the group consisting of ethylene, propylene, 1-butene, 1-pentene, 1-hexene, 1-heptene, 1-octene, and 1-nonene. Preferably, the aliphatic olefin monomer is ethylene and/or propylene. The cyclic olefin monomer may, for example, comprise one or more selected from the group consisting of norbornene, phenyl norbornene, tetracyclododecene norbornene, dicyclopentadiene, dimethyloctahydronaphthalene, and cyclopentene. Preferably, the cyclic olefin monomer comprises one or more norbornene derivatives and/or one or more cyclopentene derivatives. The aliphatic olefin monomer and cyclic olefin monomer may further copolymerise with linear and/or branched aliphatic and/or aromatic compounds. Suitable cyclic olefin copolymers, for example, are commercially obtained from Mitsui Chemicals, and TOPAS Advanced Polymers.

The cyclic olefin polymer may comprise a mixture of cyclic olefin homopolymers and cyclic olefin copolymers in a ratio of 1:20 to 20:1. In particular, the ratio between cyclic olefin homopolymers and cyclic olefin copolymers may be 1:10 to 10:1. Preferably, the ratio is 1:5 to 5:1. The mixture may comprise at least one cyclic olefin homopolymer comprising one or more selected from the group consisting of norbornene, norbornene derivatives, and cyclopentene derivatives, and at least one cyclic olefin copolymer comprising one or more selected from the group consisting of norbornene derivatives, cyclopentene derivatives, ethylene and propylene. Preferably, the mixture of cyclic olefin homopolymers and cyclic olefin copolymers comprises norbornene derivatives, and ethylene or propylene, or cyclopentene derivatives, and ethylene or propylene.

A concentrate may be prepared wherein the cyclic olefin polymer typically has a melting point (Tₘ) of about 75-500° C., such as about 100-450° C. When the cyclic olefin polymer comprises one or more cyclic olefin homopolymers, the melting point may be about 100-450° C., such as about 120-400° C. Preferably, the melting point is 125-350° C. When the cyclic olefin polymer comprises one or more cyclic olefin copolymers, the melting point may be about 100-450° C., such as about 120-400° C. Preferably, the melting point is 125-350° C. In particular, when the cyclic olefin polymer comprises a mixture of cyclic olefin homopolymers and cyclic olefin copolymers, the melting point may be about 100-450° C., such as 125-350° C.

A concentrate may be prepared wherein the cyclic olefin polymer typically has a glass transition point (T_{g}) of about 75-250° C., such as about 145-235° C. When the cyclic olefin polymer comprises one or more cyclic olefin homopolymers, the glass transition point may be about 75-250° C., such as about 145-235° C. Preferably, the glass transition point is 150-225° C. When the cyclic olefin polymer comprises one or more cyclic olefin copolymers, the glass transition point may be about 75-250° C., such as about 140-235° C. Preferably, the glass transition point is 150-225° C. In particular, when the cyclic olefin polymer comprises a mixture of cyclic olefin homopolymers and cyclic olefin copolymers, the glass transition point may be about 75-250° C., such as 145-235° C.

A concentrate comprising titanium dioxide and cyclic olefin polymer may further comprise one or more aliphatic polymers, such as aliphatic homopolymers and/or aliphatic copolymers (viz. other than cyclic olefin copolymer). Examples of such aliphatic polymers may be polyethylene and polypropylene. Adding an aliphatic polymer to the concentrate may reduce the cost per weight product, while negatively influencing light protection to a minor extent. An aliphatic polymer may be present in the concentrate in an amount without significantly influencing the transmittance property nor the specific colour nor other desired properties. The amount of aliphatic polymer in the concentrate may be 40% or less, based on the total weight of the concentrate, such as 35% or less. The amount of the aliphatic polymer in the concentrate may be 30% or less, based on the total weight of the concentrate, such as 25% or less, or 15% or less. The amount of aliphatic polymer in the concentrate may be 0.5% or more, based on the total weight of the concentrate, such as 5% or more. When the amount of aliphatic polymer is more than 40% by total weight of the concentrate, the concentrate may not contribute sufficiently to the light protection property of preform and/or container.

A concentrate comprising titanium dioxide and cyclic olefin polymer may further comprise one or more aromatic polymers, such as aromatic homopolymers and/or aromatic copolymers, in particular aromatic polymers other than polyesters. Examples of such aromatic polymers may be polystyrene, polysulphone, polyphenylsulphone, and acrylonitrile-butadiene-styrene. Adding an aromatic polymer to the concentrate may reduce the cost per weight product, while negatively influencing light protection to a minor extent. The aromatic polymer may be present in the concentrate in an amount without significantly influencing the transmittance property nor the specific colour nor other desired properties. The amount of aromatic polymer in the concentrate may be 40% or less, based on the total weight of the concentrate, such as 35% or less. The amount of the aromatic polymer in the concentrate may be 30% or less, based on the total weight of the concentrate, such as 25% or less, or 15% or less. The amount of aromatic polymer in the concentrate may be 0.5% or more, based on the total weight of the concentrate, such as 5% or more. When the amount of aromatic polymer is more than 40% by total weight of the concentrate, the concentrate may not contribute sufficiently to the light protection property of preform and/or container.

A concentrate comprising titanium dioxide and cyclic olefin polymer may further comprise a polyester. The polyester may comprise one or more selected from the group consisting of aliphatic homopolymer polyesters, aliphatic copolymer polyesters, semi-aromatic copolymer polyesters, semi-aromatic homopolymer polyesters, aromatic copolymer polyesters, and aromatic homopolymer polyesters. Adding polyester to the concentrate may decrease the cost per product weight, while negatively influencing transmittance to a minor extent. The amount of polyester in the concentrate may be 80% or less, based on the total weight of the concentrate, such as 70% or less. The amount of polyester in concentrate may be 60% or less, based on the total weight of the concentrate, such as 50% or less, or 30% or less. The amount of polyester in the concentrate may be 1% or more, based on the total weight of the concentrate, such as 10% or more. When the amount of polyester is more than 80% by total weight of the concentrate, the concentrate may not contribute sufficiently to the light protection property of preform and/or container. Preferably, the amount of polyester ranges from 1-30% by total weight of the concentrate.

Suitable polyesters include a condensation product of a diprotic acid and a glycol, such as a condensation product of i) a dicarboxylic acid or an anhydride and ii) a glycol. Typically, the diprotic acid comprises an aromatic diprotic acid, or ester or anhydride thereof, such as isophthalic acid, terephthalic acid, naphthalene-1,4-dicarboxylic acid, naphthalene-2,6-dicarboxylic acid, phthalic acid, phthalic anhydride, tetrahydrophthalic anhydride, trimetallitic anhydride, diphenoxyethane-4,4′-dicarboxylic acid, diphenyl-4,4′-dicarboxylic acid, and mixtures thereof. The diprotic acid also can be an aliphatic diprotic acid or anhydride, such as adipic acid, sebacic acid, decane-1,10-dicarboxylic acid, fumaric acid, succinic anhydride, succinic acid, cyclohexanediacetic acid, glutaric acid, azeleic acid, and mixtures thereof. Other aromatic and aliphatic diprotic acids known to the person skilled in the art can as well be used. Preferably, the diprotic acid comprises an aromatic diprotic acid. Optionally the diprotic acid comprising an aromatic diprotic acid, further comprises 20% or less, by weight of the diprotic acid component, of an aliphatic diprotic acid.

The glycol, or diol, component of the polyester comprises ethylene, glycol, propylene glycol, butane-1,4-diol, diethylene glycol, a polyethylene glycol, a polypropylene glycol, neopentyl glycol, a polytetramethylene glycol, 1,6-xylene glycol, pentane-1,5-diol, 3-methylpentanediol-(2,4), 2-methylpentanediol-(1,4), 2,2,4-trimethylpentanediol-(1,3), 2-ethylhexanediol-(1,3), 2,2-diethylpropanediol-(1,3), hexanediol-(1,3), 1,4-di-(hydroxyethoxy)benzene, 2,2-bis(4-hydroxycyclohexyl)propane, 2,4-dihydroxy-1,1,3,3-tetramethylcyclobutane, 2,2-bis(3-hydroxyethoxyphenyl)propane, 2,2-bis(4-hydroxypropoxyphenyl)propane, 1,4-dihydroxymethylcyclohexane, and mixtures thereof. Additional glycols known to the person skilled in the art can as well be used as the glycol component of the diluent polyester.

The polyester preferably comprises PET, and for example, virgin bottle grade PET or recycled PET (r-PET), cyclohexane dimethanol/PET copolymer (PETG), polyethylene naphthalate (PEN), polyethylene furanoate (PEF), polybutylene terephthalate (PBT), and mixtures thereof. Suitable polyesters can as well include polymer linkages, side chains, and end groups different from the formal precursors of the simple polyesters previously specified.

The suitable polyesters typically have an intrinsic viscosity of 0.2 or more to 1.2 or less at 25° C., and more preferably 0.6 or more to 0.9 or less at 25° C., for an average 60/40 blend of phenol/1,1,2,2-tetrachloroethane solvent mixture. In the case of PET, an intrinsic viscosity value of 0.6 at 25° C. may correspond to a viscosity average molecular weight of 36 kDa, and an intrinsic viscosity value of 1.2 at 25° C. may correspond to a viscosity average molecular weight of 103 kDa. Intrinsic viscosity as disclosed herein is determined according to ASTM D4603, Standardised Test Method for Determining Inherent Viscosity of PET. Other methods to determine viscosity of polyesters like using capillary rheometry are also possible and commonly known to the person skilled in the art.

A concentrate comprising titanium dioxide and cyclic olefin polymer may further comprise one or more of the above aliphatic polymers (viz. other than cyclic olefin copolymer) and/or one or more of the above aromatic polymers, in particular aromatic polymers other than polyesters, and/or one or more of the above polyesters.

A concentrate comprising titanium dioxide and cyclic olefin polymer may further comprise one or more light absorbing additives in order to improve the light transmittance properties of the final packaging. The one or more light absorbing additives absorb light in the wavelength range of 200-2500 nm. In particular, the one or more light absorbing additives absorb light in the wavelength range of 210-1500 nm, such as 250-1000 nm. Preferably, the one or more light absorbing additives absorb light in the wavelength range of 275-780 nm, such as 300-750 nm. The one or more light absorbing additives may for example be organic compounds, inorganic compounds, and/or a mixture thereof.

In an embodiment, the concentrate as described herein, suitable for colouring polymers, such as polyester, comprises 50% or more of titanium dioxide, 20% or less of a wax, and 30% or less of polyester, and absorbs light in the wavelength range of 250-1000 nm, such as 275-780 nm, and preferably 300-750 nm. In particular, the wax comprises one or more selected from the group of natural oil based waxes, such as glycerol monostearate, magnesium stearate, zinc stearate, hydrogenated castor oil, amide waxes, such as stearamide, ethylene bis(stearamide), and synthetic waxes, such as monoesters of stearic acid, polyethoxylated glycols and derivatives, and esters of pentaerythritol, polyethylene waxes and ethylenevinylacetate waxes. The concentrate can comprise one or more additional light absorbing additives.

Organic light absorbing additives may, for example, comprise one or more selected from Solvent Yellow 43 (CAS number 19125-99-6/1226-96-9), Solvent Yellow 72 (CAS number 61813-98-7), Solvent Yellow 93 (CAS number 4702-90-3/61969-52-6), Solvent Yellow 114 (CAS number 75216-45-4), Disperse Yellow 64 (CAS number 10319-14-9), Disperse Yellow 201 (CAS number 80748-21-6), Disperse Yellow 241 (CAS number 83249-52-9), Solvent Violet 36 (CAS number 61951-89-1), Solvent Red 23 (CAS number 85-86-9), Solvent Red 26 (4477-79-6), Solvent Red 111 (CAS number 82-38-2), Solvent Red 135 (CAS number 71902-17-5), Solvent Red 149 (CAS number 71902-18-6/21295-57-8), Solvent Red 179 (CAS number 89106-94-5), Solvent Red 195 (CAS number 164251-88-1), Solvent Red 207 (CAS number 15958-68-6), Solvent Green 3 (CAS number 128-80-3), Solvent Green 28 (CAS number 71839-01-5), Disperse Blue 60 (CAS number 12217-80-0), Solvent Blue 36 (CAS number 14233-37-5), Solvent Blue 97 (CAS number 61969-44-6), Solvent Blue 101 (CAS number 6737-68-4), Solvent Blue 104 (CAS number 116-75-6), Solvent Orange 60 (CAS number 61969-47-9/6925-69-5), Disperse Orange 47 (CAS number 12236-03-2) and Solvent Black 7 (CI number 50415:1; CAS number 8005-02-5). Suitable organic light absorbing additives are for example commercially available from companies like Milliken.

Inorganic light absorbing additives that may reduce the transmittance of the portion of UV and visible light may comprise one or more metal oxides comprising metals consisting from the group of Ni, Fe, Mn, Ti, Co, Cr, Cu, Sn, and Sb. Furthermore, pigments consisting from the group of Pigment Black 11 (CI number 77499; CAS number 12227-89-3), Pigment Black 12 (CI number 77543; CAS number 68187-02-0), Pigment Black 28 (CI number 77428; CAS number 68186-91-4), Pigment Black 29 (CI number 77498; CAS number 68187-50-8), Pigment Black 30 (CI number 77504; CAS number 71631-15-7), Pigment Black 33 (CI number 77537; CAS number 68186-94-7 or 75864-23-2), Pigment Brown 29 (CI number 77500; CAS number 12737-27-8), Pigment Blue (CI number 77007; CAS number 057455-37-5), Pigment Green 17 (CI number 77288; CAS number 1308-38-9) and mixtures thereof may be present in the concentrate to improve the light protection property. The pigments are for example commercially available from companies like The Shepherd Color Company. Examples of other light absorbing additives may be aluminium powder, graphitic carbon, and carbon black.

The above-mentioned one or more light absorbing additives may be present in the concentrate in an amount of up to 10%, based on the total weight of the concentrate. In particular, the amount in which the one or more light absorbing additives are present in the concentrate is 9% or less by total weight of the concentrate, such as 8% or less, 7% or less, 6% or less, 5% or less, 4% or less, 3% or less, 2% or less, or 1% or less. Preferably, the amount of light absorbing additives is in the range of 0-1% by total weight of the concentrate, such as 0.05-1%. When the amount of light absorbing additives is above 10% by total weight of the concentrate, the cost effectiveness may be negatively impacted, and/or less ideal properties are acquired. An amount of less than 3% by total weight of the concentrate, may improve the light transmittance property of the final packaging.

The concentrate according to the invention may further include optional additives that do not adversely affect the desired properties of the preforms or containers prepared therefrom. The optional additives include, but are not limited to, scavengers, such as acetaldehyde scavengers and oxygen scavengers, stabilisers, antioxidants, visible light screening agents, UV light screening agents, extrusion aids, drying agents, fillers, anti-clogging agents, crystallisation aids, impact modifiers, additives designed to make the polymer more (bio-)degradable or combustible, and mixtures thereof. Preferably, the optional additives are used in an amount to provide a specific colour and/or to enhance the light protection of the preforms and/or containers prepared therefrom. The optional additives may be present in the concentrate in an amount neither adversely influencing the light transmittance property nor the specific colour nor other said desired properties.

The (optional) additives may be present in the concentrate in an amount of up to 10%, based on the total weight of the concentrate. In particular, these additives are present in the concentrate in amounts of 7.5% or less by total weight of the concentrate, such as 5% or less, or 2.5% or less.

The concentrate as described herein may be prepared by bringing cyclic olefin polymer in contact with titanium dioxide. The process of preparing the concentrate may be performed at a temperature whereat the titanium dioxide can be dispersed in the continuous phase. Herewith, the continuous phase may comprise one or more aliphatic polymers and/or one or more aromatic polymers and/or one or more polyesters, as described herein. Preferably, the continuous phase comprises cyclic olefin polymer as described herein. More preferably, the continuous phase comprises cyclic olefin polymer if the concentrate does not further comprise one or more polyesters and/or one or more aliphatic polymers and/or one or more aromatic polymers. The temperature of the continuous phase may approach or surpass the melting point of the continuous phase. The molten concentrate may be cooled to below solidification temperature when the titanium dioxide may be dispersed in the continuous phase, or medium, resulting in a solid concentrate. When the titanium dioxide is not be properly dispersed and/or homogenised, it may negatively influence the effect of the concentrate in the final application. For example, the light protection of the final packaging may be negatively influenced.

In accordance with the invention, a compound formulation comprising titanium dioxide, cyclic olefin polymer, and polyester is provided, wherein the amount of titanium dioxide is 20% or less, and the amount of cyclic olefin polymer is 1-15%, based on the total weight of the compound formulation.

In an embodiment, a compound formulation is provided comprising the concentrate as described herein and polyester, wherein the amount of concentrate is about 2.5-30%, based on the total weight of the compound formulation. In particular, the compound formulation comprises an amount of concentrate of 25% or less, and 5% or more by total weight of the compound formulation.

In an embodiment, a process for preparing a compound formulation is provided, the process comprising producing the compound formulation by mixing the concentrate as described herein and polyester, wherein the amount of concentrate is about 2.5-30%, such as 5-25% based on the total weight of the compound formulation. The process may further comprise an optional step with which additional cyclic olefin polymer and/or titanium dioxide and/or polyester is added and mixed before mixing and/or during mixing and/or after mixing the concentrate and polyester. With the optional step the amount of cyclic olefin polymer added is about 0.5-10% by total weight of the compound formulation. The amount of titanium dioxide to be added with the optional step is about 0.5-15%, based on the total weight of the compound formulation. Alternatively, the compound formulation may be prepared by mixing individual components, such as cyclic olefin polymer, titanium dioxide and polyester together.

In another embodiment, a process for preparing a compound formulation is provided, the process comprising producing the compound formulation by mixing titanium dioxide, cyclic olefin polymer, and polyester, wherein the amount of titanium dioxide is 20% or less, and the amount of cyclic olefin polymer is 1-15%, based on the total weight of the compound formulation. The process may further comprise an optional step with which concentrate as described herein is added and mixed before mixing and/or during mixing and/or after mixing the titanium dioxide, cyclic olefin polymer, and polyester. With the optional step the amount of concentrate added is about 1-10% by total weight of the compound formulation.

The compound formulation as described herein may be used to prepare monolayered and multilayered polyester preforms and/or containers having a lower amount of abrasive titanium dioxide content that do not reduce the lifespan of the moulds.

The term “compound formulation” as used in this context is meant to refer to a formulation wherein powders are compounded with one or more other ingredients, in particular a resin, e.g. polyester. Such a formulation can be directly used to prepare a preform. The term “compound formulation” differs from the term “concentrate” in that the compound formulation comprises a significantly higher concentration polyester. Moreover, the compound formulation may be prepared by using a concentrate as described herein and/or with one or more other ingredients, in particular a resin, e.g. polyester, therefore the compound formulation may not be the concentrate. The compound formulation may be prepared by using titanium dioxide, cyclic olefin polymer and one or more other ingredients, in particular a resin, e.g. polyester. As a result, when compared to a concentrate according to the invention the compound formulation comprises lower concentrations of cyclic olefin polymer and/or titanium dioxide. Some illustrative examples of the resin includes polyester resins as described herein. Further additives may be present as well in the compound formulation.

The compound formulation may comprise 99% or less and 65% or more resin, based on the total weight of the compound formulation. In particular, the amount of resin may be 70-98.5% by total weight of the compound formulation, such as 75-98%, or preferably 85-97%.

The compound formulation may comprise 15% or less and 1% or more cyclic olefin polymer, based on the total weight of the compound formulation. In particular, the amount of cyclic olefin polymer may be 1-12.5% by total weight of the compound formulation, such as 1-10%, or preferably 1-5%.

The compound formulation may comprise 20% or less of titanium dioxide by total weight of the compound formulation. In particular, the amount at which the titanium dioxide may be present in the compound formulation is 15% or less by total weight of the compound formulation, such as 14% or less, 13% or less, 12% or less, 11% or less, 10% or less, 9% or less, 8% or less, 7% or less, 6% or less, 5% or less, 4% or less, 3% or less, 2% or less, or 1% or less. Preferably, the compound formulation comprises 0.5% or more of titanium dioxide by total weight of the compound formulation. More preferably, the amount of titanium dioxide is 0% to 10%, based on the total weight of the compound formulation. The most preferred amount of titanium dioxide is from 2% to 8%, based on the total weight of the compound formulation.

The compound formulation as described herein may further comprise one or more other ingredients, such as the above light absorbing additives and/or optional additives. The amount of one or more other ingredients in the compound formulation may comprise 10% or less, based on the total weight of the compound formulation. In particular, the amount of the one or more other ingredients may be present in the compound formulation is 0.05% or more and 7.5% or less by total weight of the compound formulation, such as 7% or less, 6% or less, 5% or less, 4% or less, 3% or less, 2% or less, or 1% or less. Preferably, the amount of the one or more other ingredients is 0.05-5% by total weight of the compound formulation. More preferably, the amount of the one or more other ingredients in the compound formulation is 0.05-3% by total weight of the compound formulation.

The compound formulation may comprise resin, in particular polyester, 1-15% of cyclic olefin polymer, such as 1-5%, and 20 wt. % or less of titanium dioxide, such as 0.5-15%, based on the total weight of the compound formulation.

The concentrate as described herein may be used for colouring polyester. The polyester may comprise polyester-based materials, including fabrics, fibres, preforms, films, canoes, displays, holograms, filters, insulation, vehicles, instruments, and packaging, though, not limited hereto. In particular, preforms for bottles, bottles, and other containers are preferred.

In an embodiment, the concentrate according to the invention may be used in a preform for containers. Such a preform may comprise an amount of cyclic olefin polymer of 10% or less by total weight of the preform. Preferably, the amount at which cyclic olefin polymer may be present in the preform is 9% or less by total weight of the preform, such as 8% or less, 7% or less, 6% or less, 5% or less, 4% or less, 3% or less, 2% or less, or 1% or less. Preferably, cyclic olefin polymer is present in an amount of 0.5% or more by total weight of the preform. More preferably the amount of cyclic olefin copolymer is from 1% to 5% by total weight of the preform. When the amount of cyclic olefin copolymer is below 1% by total weight of the preform, light transmittance of the preform may be too high.

The preform may comprise an amount of titanium dioxide of 15% or less by total weight of the preform. In particular, the amount at which titanium dioxide is present in the preform is 14% or less by total weight of the preform, such as 13% or less, 12% or less, 11% or less, 10% or less, 9% or less, 8% or less, 7% or less, 6% or less, 5% or less, 4% or less, 3% or less, 2% or less, or 1% or less. Preferably, titanium dioxide is present in an amount of 0.5% or more by total weight of the preform. More preferably the amount of titanium dioxide is 0 to 8% by total weight of the preform. When the amount of titanium dioxide is above 15% by total weight of the preform, physical properties of the preform may be negatively influenced, such as blowing of a preform and mechanical properties of both the container as well as the polymer may be hampered. When the amount of titanium dioxide is above 4% by total weight of the preform, multi-layered structures may not be necessary to obtain desired light protection for containers. When titanium dioxide is absent in the preform, the light-shielding property is negatively influenced and higher amounts of for example cyclic olefin polymer are needed, resulting in higher costs and subsequently less ideal properties.

In accordance with the invention, a process for preparing coloured polyester is provided, the process comprising producing coloured polyester by bringing polyester into contact with the concentrate according to the invention and/or the compound formulation according to the invention.

The coloured polyester as prepared by the herein described process for preparing coloured polyester may be a polyester preform for bottles and other containers. The coloured polyester may further be a polyester bottle and/or other container.

The coloured polyester may comprise an amount of cyclic olefin polymer of 10% or less by total weight of the coloured polyester. In particular, the amount of cyclic olefin polymer may be 0% or more, 9% or less, 8% or less, 7% or less, 6% or less, 5% or less, 4% or less, 3% or less, 2% or less, or 1% or less based on the total weight of the coloured polyester. Preferably, the amount of cyclic olefin polymer in the coloured polyester is 0-6% by total weight of the coloured polyester, more preferably 1-5%.

The coloured polyester may comprise an amount of titanium dioxide of 15% or less by total weight of the coloured polyester. In particular, the amount of titanium dioxide may be 0% or more, 14% or less, 13% or less, 12% or less, 11% or less, 10% or less, 9% or less, 8% or less, 7% or less, 6% or less, 5% or less, 4% or less, 3% or less, 2% or less, or 1% or less, based on the total weight of the coloured polyester. Preferably, the amount of titanium dioxide in the coloured polyester is 0.5% or more by total weight of the coloured polyester, more preferably 0.5-10%, even more preferably 2-8%.

The invention is also directed to the process of preparing containers suitable for storing solids and/or liquids, wherein said process comprises producing a preform for said containers. Herewith, the containers may comprise one or more polymeric materials. In particular, polyester is preferred. The polyester may not necessarily be identical to the above polyester which may be added to the concentrate, compound formulation and/or the preform. The preform for the containers may comprise a polyester and a concentrate, a polyester and a compound formulation, or a polyester, a concentrate and a compound formulation. The containers may be prepared by moulding, in particular blow moulding, such as extrusion blow moulding, one stage injection stretch blow moulding or two stage injection stretch blow moulding.

The polymeric material may comprise any compound constituted of repeating monomer units. The monomer units can homopolymerise or copolymerise with linear and/or branched aliphatic and/or aromatic compounds. In particular, a polyester is preferred. The polyester may not necessarily be similar to the polyester that may be present in the concentrate, compound formulation and/or the preform as described herein. The polyester may comprise one or more selected from the group consisting of aliphatic homopolymer polyesters, aliphatic copolymer polyesters, semi-aromatic copolymer polyesters, semi-aromatic homopolymer polyesters, aromatic copolymer polyesters, and aromatic homopolymer polyesters, though, not limited hereto. In particular, PET, PETG, PBT, PEF, and/or PEN may be selected. Suitable polyesters can as well include polymer linkages, side chains, and end groups different from the formal precursors of the (simple) polyesters previously specified.

The prepared containers may have transmittance of 4% or less, measured at a wavelength of 550 nm and having an average wall thickness of 0.25 mm. Preferably, the prepared containers have transmittance of 4% or less, measured at a wavelength range between 200-750 nm. In the context of this invention, this means that over the entire 200-750 nm spectrum the transmittance does not exceed 4%. In particular, the percent transmittance may be 1% or less, 2% or less, or 3% or less. Preferably, the transmittance is 0-2%, measured at a wavelength of about 550 nm and an average wall thickness of 0.25 mm. More preferably the transmittance may be 0-0.5%, measured at a wavelength of about 550 nm and an average wall thickness of 0.25 mm. As described by Beer's law, samples with larger average wall thickness may have greater opacity.

The container may be prepared wherein the amount of concentrate is 15% or less by total weight of the container. Preferably, the amount at which the concentrate is present in the container is 14% or less by total weight of the container, such as 13% or less, 12% or less, 11% or less, 10% or less, 9% or less, 8% or less, 7% or less, 6% or less, 5% or less, 4% or less, 3% or less, 2% or less, or 1% or less. Preferably, the concentrate is present in an amount of 0.5% or more by total weight of the container, in particular 2-15%, more preferably 4-10%. An amount of lower than 2% by total weight of the container may result in a too low amount of cyclic olefin copolymer and titanium dioxide in the container.

The invention is also directed to containers that may be obtained by using i) the concentrate and polyester, ii) the concentrate and the preform and/or polyester, iii) the compound formulation, the concentrate and/or polyester, iv) the compound formulation and the preform, of the invention, and/or by performing the process of preparing containers of the invention.

The container may comprise an amount of cyclic olefin polymer of 10% or less by total weight of the container. In particular, the amount at which the cyclic olefin polymer may be present in the container is 9% or less by total weight of the container, such as 8% or less, 7% or less, 6% or less, 5% or less, 4% or less, 3% or less, 2% or less, or 1% or less. Preferably, cyclic olefin polymer is present in an amount of 0.5% or more by total weight of the container, more preferably 0-6%, even more preferably 1-5%. An amount of cyclic olefin polymer below 1% by total weight of the container may result in a too high light transmittance of the preform, based on a container with an average wall thickness of 0.25 mm.

The container may comprise an amount of titanium dioxide of 15% or less by total weight of the container. In particular, the amount at which the titanium dioxide may be present in the container is 14% or less by total weight of the container, such as 13% or less, 12% or less, 11% or less, 10% or less, 9% or less, 8% or less, 7% or less, 6% or less, 5% or less, 4% or less, 3% or less, 2% or less, or 1% or less. Preferably, titanium dioxide is present in an amount of 0.5% or more by total weight of the container, more preferably 0.5-10%, even more preferably 2-8%.

The container may further comprise one or more previously described aliphatic polymers and/or aromatic polymers. Preferably, the aliphatic polymer(s) and/or aromatic polymer(s) are not similar to the aliphatic and/or aromatic polymer(s) present in the concentrate. Accordingly, if the container comprises such further aliphatic polymers, then these further aliphatic polymers are preferably aliphatic polymers other than cyclic olefin polymer. Likewise, if the container comprises such further aromatic polymers, then these further aromatic polymers are preferably aromatic polymers other than polyesters.

The container may comprise an amount of 40% or less of such aliphatic polymer, by total weight of the container. Preferably, the amount of aliphatic polymer is 5% or less, based on the total weight of the container. More preferably, an aliphatic polymer (other than cyclic olefin polymer) is not present in the container.

The container may comprise an amount of 40% or less of such aromatic polymer (in particular an aromatic polymer other than polyester), by total weight of the container. Preferably, the amount of aromatic polymer is 5% or less, based on the total weight of the container. More preferably, the container is free from aromatic polymer (other than aromatic polyester).

The invention has been described by reference to various embodiments, and methods. The skilled person understands that features of various embodiments and methods can be combined with each other.

All references cited herein are hereby completely incorporated by reference to the same extent as if each reference were individually and specifically indicated to be incorporated by reference and were set forth in its entirety herein.

The use of the terms “a” and “an” and “the” and similar referents in the context of describing the invention (especially in the context of the claims) are to be construed to cover both the singular and the plural, unless otherwise indicated herein or clearly contradicted by context. The terms “comprising”, “having”, “including” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. For the purpose of the description and of the appended claims, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

Preferred embodiments of this invention are described herein. Variation of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject-matter recited in the claims appended hereto as permitted by applicable law. Moreover, any combination of the above-described elements in all possible variations thereof is encompassed by the invention unless otherwise indicated herein or otherwise clearly contradicted by context. The claims are to be construed to include alternative embodiments to the extent permitted by the prior art.

For the purpose of clarity and a concise description features are described herein as part of the same or separate embodiments, however, it will be appreciated that the scope of the invention may include embodiments having combinations of all or some of the features described.

Hereinafter, the invention will be illustrated in more detail, according to specific examples. However, the invention may be embodied in many different forms and should not be construed as being limited to the embodiments set forth herein. Rather, these example embodiments are provided so that this description will be thorough and complete, and will fully convey the scope of the invention to those skilled in the art.

### EXAMPLES

### Example 1

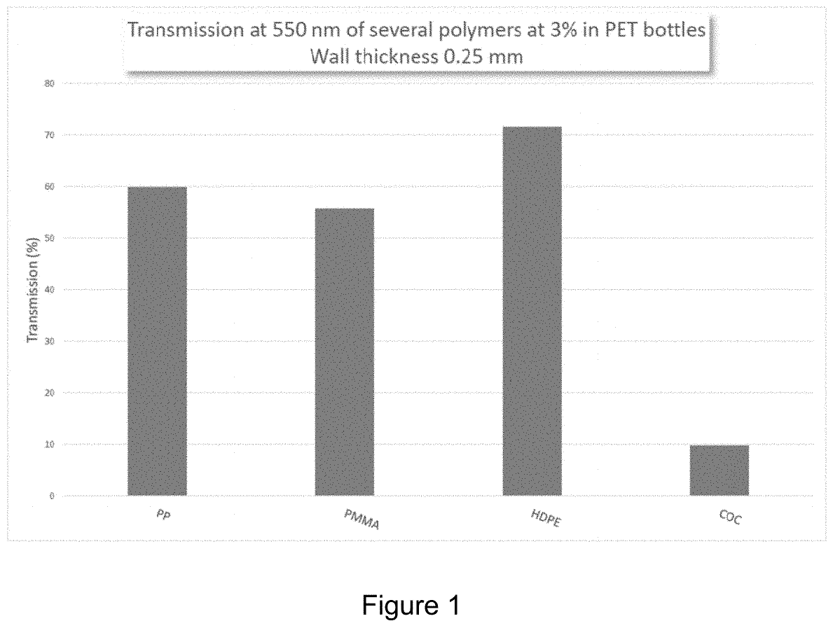

PET bottles were prepared including 3 wt. % of selected polymers. These polymers were PP Hostalen XN112-I (random copolymer polypropylene from LyondellBasell Industries), PMMA PLEXIGLAS® 8N (polymethylmethacrylate from Evonik Industries), HDPE Purell GF4760 (high density polyethylene from LyondellBasell Industries), and COC (TOPAS Advanced Polymers). The polyester preforms (Invista T94N PET resin (IV=0.84 dl/g)), 25 g preform for 0.5 litre bottle with PCO neck finish) were made on an Arburg Allrounder 320 (extruder temperature profile, hot runner temperatures were set at 285° C.), equipped with a Piovan T200 dryer and DB-60 control unit (PET was dried to a dew point of −45° C.). Dosing of the polymer into the PET base resin was done using a Movacolor MCBalance. Preforms were blown on a Corpoplast LB01 using standard PET bottle blowing settings. The transmittance curves from 200 to 750 nm of the blown bottles (0.25 mm wall thickness) were collected using a Cary 5000 spectrometer equipped with an integrating sphere. The percent transmittance at 550 nm was determined from the transmittance curves and is shown in FIG. 1. As can be seen, the amount of light transmitted using cyclic olefin copolymer is significantly lower, at the critical wavelength of below 550 nm and below, than with the selected standards at the concentration of 3%.

### Example 2

A mixture of 800 gram polymer and 1200 gram titanium dioxide was mixed and processed on a laboratory extruder (APV 19 mm twin screw) with a temperature profile between 270 and 240° C. at 300 rpm. The percentage of polymer by weight included in the concentrate is 40, the weight of titanium dioxide included in the concentrate is 60%.

Several concentrates were prepared as described above, with the selected carrier polymers from Example 1. The concentrates containing these polymers were used to prepare polyester preforms and bottles.

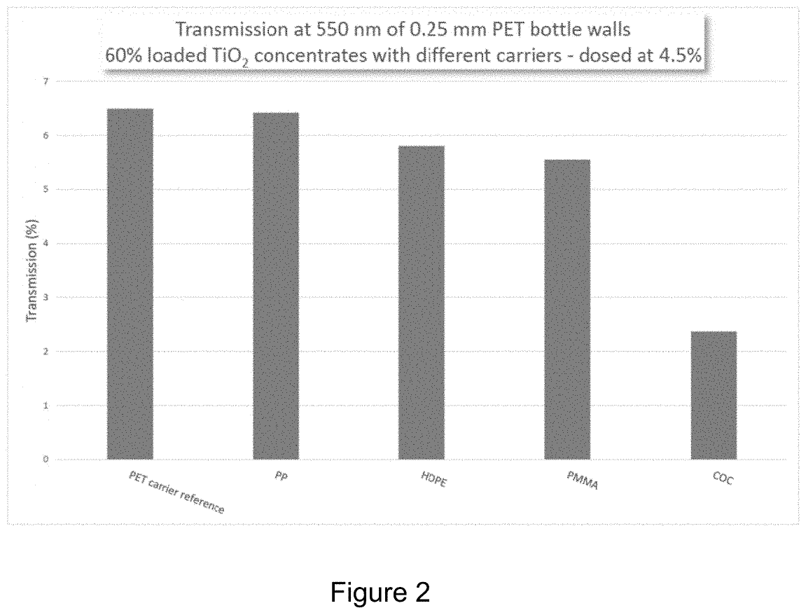

The colour concentrates were used to produce polyester (PET) preforms (Invista T94N resin (IV=0.84 dl/g)), 25 g preform for 0.5 litre bottle with PCO neck finish) on an Arburg Allrounder 320 (extruder temperature profile, hot runner temperatures were set at 285° C.), equipped with a Piovan T200 dryer and DB-60 control unit (PET was dried to a dew point of −45° C.). Dosing of the colour concentrates at 4.5 wt. % was done using a Movacolor MCBalance. Preforms were blown on a Corpoplast LB01 using standard PET bottle blowing settings. The transmittance curves from 200 to 750 nm of the blown bottles were collected using a Cary 5000 equipped with an integrating sphere. The percent transmittance at 550 nm was determined from the transmittance curves and is shown in FIG. 2. As can be seen, the amount of light transmitted using cyclic olefin copolymer results in transmittance values of below 3%, compared to comparative industrial carriers.

### Example 3

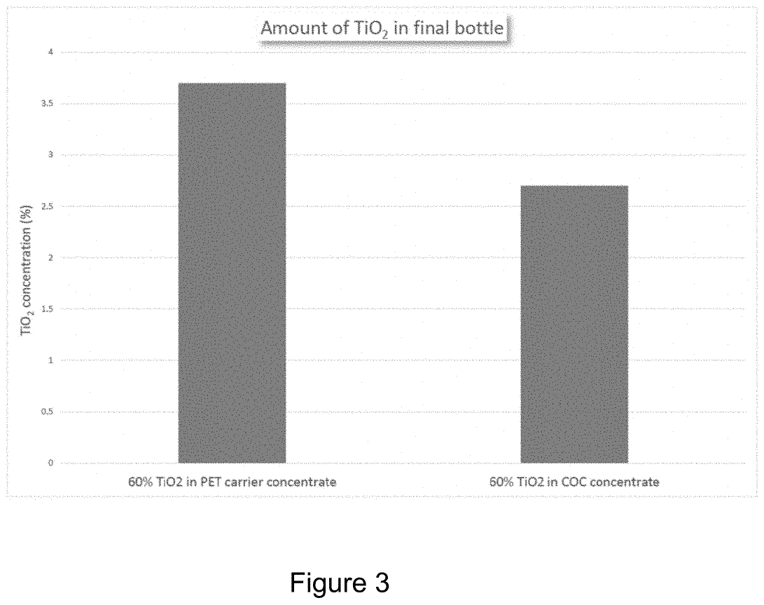

From example 2, bottles with colour concentrates were further examined. The light transmittance of the bottle with COC as carrier was 2.4%. To match this transmittance, bottles were prepared with the concentrate having PET as carrier resin at different dosing levels. This was at a 6.2% dosing level of that concentrate. The titanium dioxide content was determined by performing an ash test on the bottles by heating the coloured polyester at 800° C. during 6 hours in a Carbolite Furnace (type CSF1100). As can be seen from FIG. 3, the amount of titanium dioxide in the bottle of the invention was remarkably lower.

The inventors found that the amount of titanium dioxide in the bottles to achieve a light transmittance at 550 nm of 0.2% in the bottles was remarkably lower for the claimed invention.

1. A concentrate comprising 10-90% by total weight of the concentrate of cyclic olefin polymer, and 20-80% by total weight of the concentrate of titanium dioxide.

2. The concentrate of claim 1, wherein the cyclic olefin polymer comprises one or more cyclic olefin copolymers.

3. The concentrate of claim 1, wherein the cyclic olefin comprises one or more cyclic olefin homopolymers.

4. The concentrate of claim 1, wherein cyclic olefin polymer comprises one or more selected from the group consisting of ethylene-norbornene copolymer, ethylene-phenyl norbornene copolymer, ethylene-tetracyclododecene norbornene copolymer, ethylene-dicyclopentadiene copolymer, norbornene homopolymer, phenyl norbornene homopolymer, tetracyclododecene norbornene homopolymer, and dicyclopentadiene homopolymer.

5. The concentrate of claim 1, further comprising one or more selected from the group consisting of polyester, aliphatic polymer and aromatic polymer.

6. The concentrate of claim 5, wherein the polyester comprises one or more selected from the group consisting of aliphatic homopolymer polyesters, aliphatic copolymer polyesters, semi-aromatic copolymer polyesters, semi-aromatic homopolymer polyesters, aromatic copolymer polyesters, and aromatic homopolymer polyesters.

7. The concentrate of claim 5, wherein the aromatic polymer comprises one or more selected from the group consisting of polystyrene, polysulphone, polyphenylsulphone, and acrylonitrile-butadiene-styrene.

8. The concentrate of claim 5 wherein the aliphatic polymer comprises one or more selected from the group consisting of polyethylene and polypropylene.

9. The concentrate of claim 1, further comprising a light absorbing additive.

10. A compound formulation comprising titanium dioxide, cyclic olefin polymer, and polyester, wherein the amount of titanium dioxide is 20% by total weight of the compound formulation or less, and the amount of cyclic olefin polymer is 1-15% by total weight of the compound formulation.

11. A process for preparing coloured polyester, the process comprising
producing coloured polyester by bringing polyester into contact with the concentrate of claim 1 and/or
a compound formulation comprising titanium dioxide, cyclic olefin polymer, and polyester, wherein the amount of titanium dioxide is 20% by total weight of the compound formulation or less, and the amount of cyclic olefin polymer is 1 15% by total weight of the compound formulation.

12. The process of claim 11, wherein the coloured polyester is a polyester preform for bottles and other containers.

13. The process of claim 11, wherein the coloured polyester is a polyester bottle and/or other container.

14. The process of claim 11, wherein the coloured polyester comprises an amount of cyclic olefin polymer of 5% or less by total weight of the coloured polyester.

15. The process of claim 11, wherein the coloured polyester comprises an amount of titanium dioxide of 8% or less by total weight of the coloured polyester.

16. A process for preparing polyester-based containers suitable for storing solids and/or liquids and having 4% or less transmittance at 550 nm and 0.25-0.30 mm sample thickness, the process comprising
producing a preform for the polyester-based containers from polyester and the concentrate of
claim 1, and/or
a compound formulation comprising titanium dioxide, cyclic olefin polymer, and polyester, wherein the amount of titanium dioxide is 20% by total weight of the compound formulation or less, and the amount of cyclic olefin polymer is 1 15% by total weight of the compound formulation, and
moulding the preform into a container.

17. The process of claim 16, wherein the amount of concentrate is 3-8% by total weight of the polyester-based container.

18. A container product obtainable by the process of claim 16, wherein the amount of cyclic olefin polymer is 5% or less by total weight of the polyester-based container, and/or the amount of titanium dioxide is 8% or less by total weight of the polyester-based container.
